(19) United States
(12) Patent Application Publication
(10) Pub. No.: US 2023/0044373 A1
(43) Pub. Date: Feb. 9, 2023

(54) DRIVE DEVICE

(71) Applicant: EXEDY Corporation, Osaka (JP)

(72) Inventor: Yoshihiro MATSUOKA, Osaka (JP)

(21) Appl. No.: 17/858,229

(22) Filed: Jul. 6, 2022

(30) Foreign Application Priority Data
Aug. 6, 2021 (JP) 2021-130320

(51) Int. Cl. B62M 6/60; F16H 47/06; B62M 9/00; B62M 19/00

(52) U.S. Cl. CPC B62M 6/60; F16H 47/065; B62M 9/00; B62M 19/00; F16H 2045/002

(57) ABSTRACT

A drive device is configured to drive a drive part. The drive device includes a fluid coupling, an electric motor, and a human-powered drive unit. The electric motor is configured to drive the drive part through the fluid coupling. The human-powered drive unit is configured to drive the drive part through the fluid coupling.

### CROSS-REFERENCE TO RELATED APPLICATIONS

This application claims priority to Japanese Patent Application No. 2021-130320 filed Aug. 6, 2021. The entire contents of that application are incorporated by reference herein in their entirety.

### TECHNICAL FIELD

The present invention relates to a drive device.

### BACKGROUND ART

In well-known electric cars, a power, outputted from an electric motor, is transmitted to drive wheels through a reducer and a differential gear. For example, in an electric car disclosed in Japan Laid-open Patent Application Publication No. 2013-60996, the reducer is directly connected to the electric motor, and a torque is transmitted from the reducer to the drive wheels through the differential gear.

In the electric car configured as described above, electricity is supplied to the electric motor from a battery or so forth, whereby the electric motor is driven. Then, driving the electric motor is disabled in lack of electricity supplied thereto. Because of this, it is required to charge the battery when the amount of electricity left in the battery becomes small.

At present, however, infrastructure for charging has not been sufficiently constructed yet. Hence, it is concerned that the electric car cannot be moved in lack of electricity for driving the electric motor during traveling.

It is an object of the present invention to provide a drive device that can be actuated even in lack of electricity for driving an electric motor.

### BRIEF SUMMARY

A drive device according to an aspect of the present invention is a device for driving a drive part. The drive device includes a fluid coupling, an electric motor, and a human-powered drive unit. The electric motor is configured to drive the drive part through the fluid coupling. The human-powered drive unit is configured to drive the drive part through the fluid coupling.

According to this configuration, even when driving of the drive part by the electric motor becomes disabled in lack of electricity for driving the electric motor, driving of the drive part is enabled by the human-powered drive unit.

Preferably, the drive device further includes a power transmission shaft. The power transmission shaft is configured to transmit a power inputted thereto from the electric motor to the fluid coupling. The human-powered drive unit includes a human-powered shaft and a human-powered transmission part. The human-powered shaft is configured to be rotationally driven by a human drive force. The human-powered transmission part is configured to transmit a power inputted thereto from the human-powered shaft to the power transmission shaft.

Preferably, the human-powered transmission part includes either a chain or a belt.

Preferably, the drive device further includes a one-way clutch. The one-way clutch is configured to allow transmitting the power from the human-powered transmission part to the power transmission shaft and block transmitting the power from the power transmission shaft to the human-powered transmission part.

Preferably, the drive device further includes a clutch mechanism. The clutch mechanism is configured to allow and block transmitting the power from the fluid coupling to the drive part.

Overall, according to the present invention, it is possible to provide a drive device that can be actuated even in lack of electricity for driving an electric motor.

### BRIEF DESCRIPTION OF THE DRAWINGS

FIG. 1 is a schematic diagram of a drive unit.

FIG. 2 is a cross-sectional view of a torque converter.

FIG. 3 is a cross-sectional view of a type of impeller hub.

FIG. 4 is a cross-sectional view of another type of impeller hub.

FIG. 5 is a close-up view of a power output part.

FIG. 6 is a close-up view of the power output part.

FIG. 7 is a close-up view of the power output part.

### DETAILED DESCRIPTION

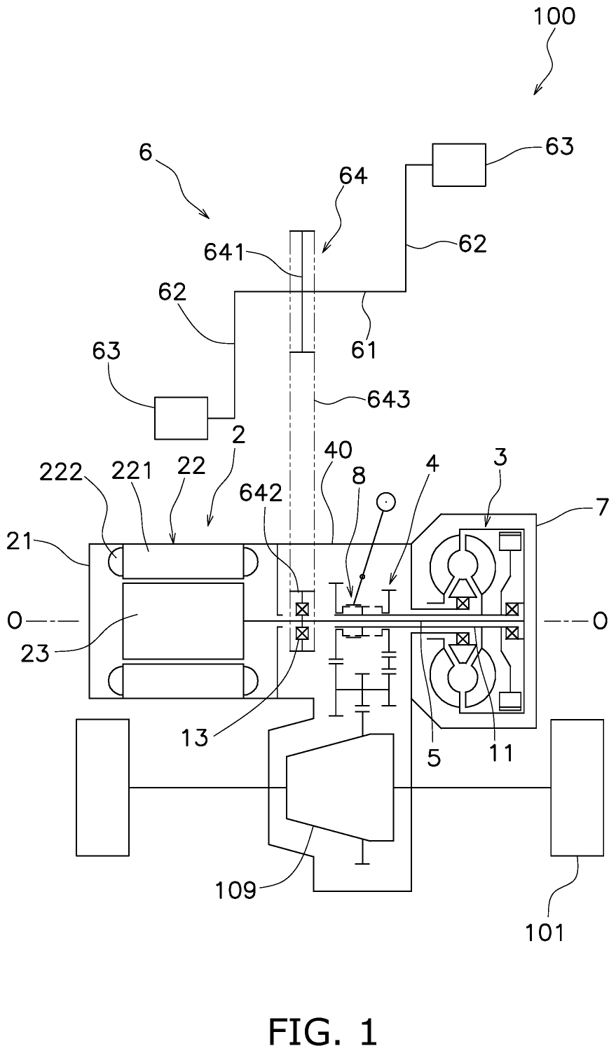

A drive device according to the present embodiment will be hereinafter explained with reference to drawings. FIG. 1 is a schematic diagram of the drive device according to the present embodiment. It should be noted that in the following explanation, the term “axial direction” refers to an extending direction of a rotational axis O for both an electric motor 2 and a torque converter 3. On the other hand, the term “circumferential direction” refers to a circumferential direction of an imaginary circle about the rotational axis O, whereas the term “radial direction” refers to a radial direction of the imaginary circle about the rotational axis O.

### [Drive Device]

As shown in FIG. 1, a drive device 100 is a device for driving drive wheels 101 (exemplary drive part). The drive device 100 includes the electric motor 2, the torque converter 3 (exemplary fluid coupling), a power output part 4, a power transmission shaft 5, a human-powered drive unit 6, an output shaft 11, a torque converter casing 7, and a clutch mechanism 8. The drive device 100 is installed in, for instance, an electric car.

### <Electric Motor 2>

The electric motor 2 is configured to drive the drive wheels 101 through the torque converter 3. In other words, a power, outputted from the electric motor 2, is transmitted to the drive wheels 101 through the torque converter 3. The electric motor 2 is driven by electricity supplied thereto from a battery (not shown in the drawings).

The electric motor 2 includes a motor casing 21, a stator 22, and a rotor 23. In the present embodiment, the electric motor 2 is of a so-called inner rotor type. The motor casing 21 is non-rotatable, while being fixed to a body frame of a vehicle or so forth.

The stator 22 is fixed to the inner peripheral surface of the motor casing 21. The stator 22 is non-rotatable. The stator 22 includes a stator core 221 and a coil 222. The stator core 221 is formed by laminating a plurality of electromagnetic steel plates. The coil 222 is wound about the stator core 221. When described in detail, the coil 222 is wound about teeth of the stator core 221.

The rotor 23 is rotated about the rotational axis O. The rotor 23 is disposed radially inside the stator 22. The electric motor 2 can be an induction motor, or alternatively, a synchronous motor. It should be noted that as described below, the rotational direction of the electric motor 2 remains unchanged regardless of forward movement and backward movement of the vehicle. Because of this, in traveling, the electric motor 2 is rotated only in a fixed direction. In other words, in traveling, the electric motor 2 is rotated only in a forward rotational direction without being rotated in a reverse rotational direction.

### <Torque Converter 3>

The torque converter 3 is disposed axially apart from the electric motor 2 at an interval. The power output part 4 is disposed between the torque converter 3 and the electric motor 2. The electric motor 2, the power output part 4, and the torque converter 3 are axially aligned in this order.

The rotational axis O of the torque converter 3 is substantially matched with that of the electric motor 2. The torque converter 3 is a device to which power, outputted from the electric motor 2, is inputted. Then, the torque converter 3 amplifies the power (torque) inputted thereto from the electric motor 2 and outputs the amplified power to the power output part 4.

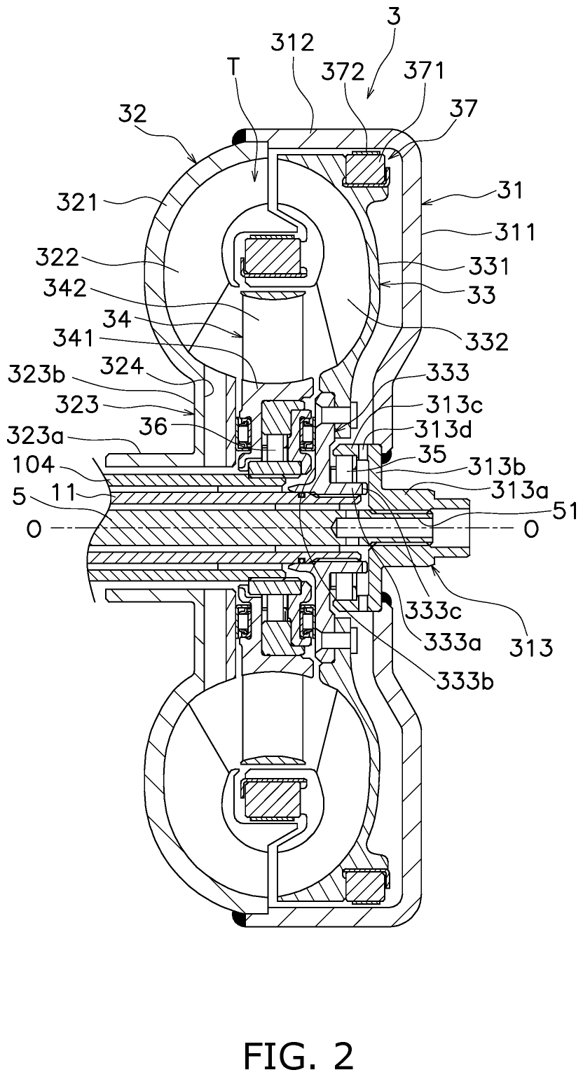

As shown in FIG. 2, the torque converter 3 includes a cover 31, an impeller 32, a turbine 33, a stator 34, and a first one-way clutch 36. Besides, the torque converter 3 further includes a centrifugal clutch 37.

The torque converter 3 is disposed such that the impeller 32 faces the electric motor 2 (the left side in FIG. 2), whereas the cover 31 faces opposite to the electric motor 2 (the right side in FIG. 2). In other words, the impeller 32 is disposed axially between the cover 31 and the electric motor 2. The torque converter 3 is accommodated in the interior of the torque converter casing 7. Hydraulic fluid is supplied to the interior of the torque converter 3. The hydraulic fluid is, for instance, hydraulic oil.

The cover 31 is a component to which the power, outputted from the electric motor 2, is inputted. The cover 31 is rotated by the power inputted thereto from the electric motor 2. The cover 31 is fixed to the power transmission shaft 5 extending from the electric motor 2. For example, the cover 31 includes a spline hole to which the power transmission shaft 5 is spline-coupled. Because of this, the cover 31 is unitarily rotated with the power transmission shaft 5. The cover 31 is disposed to cover the turbine 33.

The cover 31 includes a disc portion 311, a cylindrical portion 312, and a cover hub 313. The disc portion 311 includes an opening in the middle thereof. The cylindrical portion 312 extends from the outer peripheral end of the disc portion 311 toward the electric motor 2. The disc portion 311 and the cylindrical portion 312 are integrally formed as a single member.

The cover hub 313 is fixed to the inner peripheral end of the disc portion 311. In the present embodiment, the cover hub 313 is provided as a different member separated from the disc portion 311. However, the cover hub 313 can be formed as a single member integrated with the disc portion 311.

The cover hub 313 includes a first boss portion 313a, a first flange portion 313b, and a protruding portion 313c. The first boss portion 313a, the first flange portion 313b, and the protruding portion 313c are integrally formed as a single member.

The first boss portion 313a has a cylindrical shape and includes the spline hole. The power transmission shaft 5 is spline-coupled to the first boss portion 313a. The first boss portion 313a axially extends from the first flange portion 313b to the opposite side of the electric motor 2. The first boss portion 313a is rotatably supported by the torque converter casing 7 through a bearing member (not showing in the drawings).

The first flange portion 313b extends radially outward from the first boss portion 313a. When described in detail, the first flange portion 313b extends radially outward from the electric motor 2-side end of the first boss portion 313a. The disc portion 311 is fixed to the outer peripheral end of the first flange portion 313b.

The protruding portion 313c axially extends from the first flange portion 313b. The protruding portion 313c extends from the first flange portion 313b toward the electric motor 2. The protruding portion 313c extends from the outer peripheral end of the first flange portion 313b. The protruding portion 313c has a cylindrical shape. The protruding portion 313c includes a plurality of through holes 313d. The hydraulic fluid is discharged from the torque converter 3 through the through holes 313d.

The impeller 32 is unitarily rotated with the cover 31. The impeller 32 is fixed to the cover 31. The impeller 32 includes an impeller shell 321, a plurality of impeller blades 322, an impeller hub 323, and a plurality of supply flow pathways 324.

The impeller shell 321 is fixed to the cover 31. The plural impeller blades 322 are attached to the inner surface of the impeller shell 321.

The impeller hub 323 is attached to the inner peripheral end of the impeller shell 321. It should be noted that in the present embodiment, the impeller hub 323 is formed as a single member integrated with the impeller shell 321, but alternatively, can be formed as a different member separated from the impeller shell 321.

The impeller hub 323 includes a second boss portion 323a and a second flange portion 323b. The second flange portion 323b extends radially outward from the second boss portion 323a. The second boss portion 323a has a cylindrical shape and axially extends. The second boss portion 323a is rotatably supported by the torque converter casing 7 through a bearing member (not shown in the drawings).

A stationary shaft 104 axially extends in the interior of the second boss portion 323a. It should be noted that the stationary shaft 104 has a cylindrical shape and the output shaft 11 axially extends in the interior of the stationary shaft 104. Besides, the stationary shaft 104 extends from, for instance, a power output part casing 40 or the torque converter casing 7. The stationary shaft 104 is non-rotatable.

The supply flow pathways 324 are provided in the impeller hub 323. When described in detail, the supply flow pathways 324 are provided in the second flange portion 323b. The supply flow pathways 324 extend radially outward from the inner peripheral surface of the impeller hub 323. Besides, the supply flow pathways 324 are opened to the interior of a torus T. It should be noted that the torus T is a space enclosed by the impeller 32 and the turbine 33.

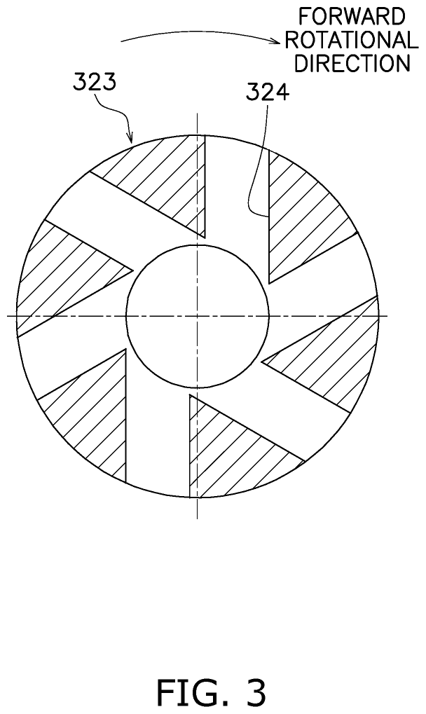

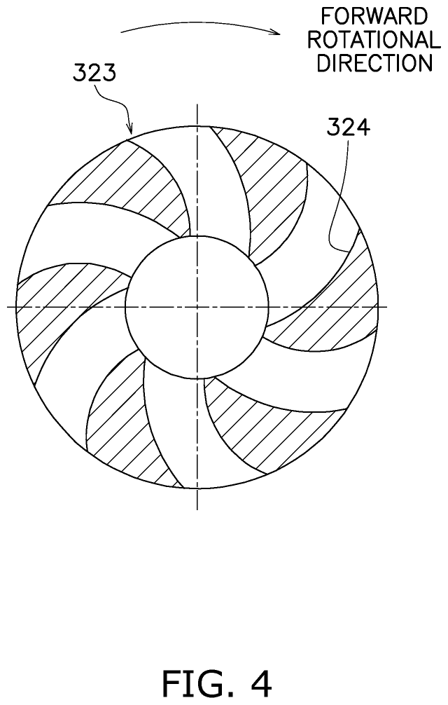

The supply flow pathways 324 are axially closed. In other words, the supply flow pathways 324 are through holes radially extending in the impeller hub 323. As shown in FIG. 3, the supply flow pathways 324 extend in a radial shape. The supply flow pathways 324 slant opposite to the rotational direction, while extending radially outward. It should be noted that the extending shape of each supply flow pathway 324 is not limited to a straight shape. For example, as shown in FIG. 4, each supply flow pathway 324 can extend in a curved shape.

As shown in FIG. 2, the turbine 33 is disposed opposite to the impeller 32. When described in detail, the turbine 33 is axially opposed to the impeller 32. The turbine 33 is a component to which the power is transmitted from the impeller 32 through the hydraulic fluid.

The turbine 33 includes a turbine shell 331, a plurality of turbine blades 332, and a turbine hub 333. The plural turbine blades 332 are fixed to the inner surface of the turbine shell 331.

The turbine hub 333 is fixed to the inner peripheral end of the turbine shell 331. For example, the turbine hub 333 is fixed to the turbine shell 331 by rivets. In the present embodiment, the turbine hub 333 is provided as a different member separated from the turbine shell 331. However, the turbine hub 333 can be formed as a single member integrated with the turbine shell 331.

The output shaft 11 is attached to the turbine hub 333. When described in detail, the output shaft 11 is spline-coupled to the turbine hub 333. The turbine hub 333 is unitarily rotated with the output shaft 11.

The turbine hub 333 includes a third boss portion 333a and a third flange portion 333b. The third boss portion 333a and the third flange portion 333b are integrally formed as a single member.

The third boss portion 333a has a cylindrical shape and includes a spline hole. The output shaft 11 is spline-coupled to the third boss portion 333a. The third boss portion 333a axially extends from the third flange portion 333b to the opposite side of the electric motor 2. In other words, the third boss portion 333a axially extends from the third flange portion 333b toward the cover hub 313.

The third boss portion 333a is disposed radially apart from the protruding portion 313c at an interval. In other words, the protruding portion 313c is disposed radially outside the third boss portion 333a. A bearing member 35 is disposed between the third boss portion 333a and the protruding portion 313c. It should be noted that without installation of the bearing member 35, the outer peripheral surface of the third boss portion 333a and the inner peripheral surface of the protruding portion 313c are opposed to each other.

At least one flow pathway is provided between the cover hub 313 and the distal end of the third boss portion 333a such that the hydraulic fluid flows therethrough. In the present embodiment, the third boss portion 333a is provided with a plurality of cutouts 333c on the distal end thereof. The cutouts 333c radially extend on the distal end of the third boss portion 333a. The hydraulic fluid is discharged from the torque converter 3 through the cutouts 333c and the through holes 313d.

The third flange portion 333b extends radially outward from the third boss portion 333a. When described in detail, the third flange portion 333b extends radially outward from the electric motor 2-side end of the third boss portion 333a. The turbine shell 331 is fixed to the outer peripheral end of the third flange portion 333b by the rivets or so forth.

The stator 34 is configured to regulate the flow of the hydraulic oil returning from the turbine 33 to the impeller 32. The stator 34 is rotatable about the rotational axis O. For example, the stator 34 is supported by the stationary shaft 104 through the first one-way clutch 36. The stator 34 is disposed axially between the impeller 32 and the turbine 33.

The stator 34 includes a stator carrier 341 having a disc shape and a plurality of stator blades 342 attached to the outer peripheral surface of the stator carrier 341.

The first one-way clutch 36 is disposed between the stationary shaft 104 and the stator 34. The first one-way clutch 36 is configured to make the stator 34 rotatable in the forward rotational direction. By contrast, the second one-way clutch 36 makes the stator 34 non-rotatable in the reverse rotational direction. The power (torque) is transmitted from the impeller 32 to the turbine 33, while being amplified by the stator 34.

The centrifugal clutch 37 is attached to the turbine 33. The centrifugal clutch 37 is unitarily rotated with the turbine 33. The centrifugal clutch 37 is configured to couple the cover 31 and the turbine 33 to each other by a centrifugal force generated in rotation of the turbine 33. When described in detail, the centrifugal clutch 37 is configured to transmit the power from the cover 31 to the turbine 33 when the rotational speed of the turbine 33 becomes greater than or equal to a predetermined value.

The centrifugal clutch 37 includes a plurality of centrifugal elements 371 and a plurality of friction materials 372. The friction materials 372 are attached to the outer peripheral surfaces of the centrifugal elements 371, respectively. The centrifugal elements 371 are disposed apart from each other at intervals in the circumferential direction. The centrifugal elements 371 are disposed to be radially movable. It should be noted that the centrifugal elements 371 are disposed to be circumferentially immovable. Because of this, the centrifugal elements 371 are rotated together with the turbine 33 and are moved radially outward by centrifugal forces.

When the rotational speed of the turbine 33 becomes greater than or equal to the predetermined value, the centrifugal clutch 37 is configured such that the centrifugal elements 371 are moved radially outward and the friction materials 372 are engaged by friction with the inner peripheral surface of the cylindrical portion 312 of the cover 31. As a result, the centrifugal clutch 37 is turned to an on state, and the power inputted to the cover 31 is transmitted therefrom to the turbine 33 through the centrifugal clutch 37. It should be noted that even when the centrifugal clutch 37 is turned to the on state, the hydraulic fluid is flowable between the centrifugal elements 371.

When the rotational speed of the turbine 33 becomes less than the predetermined value, the centrifugal elements 371 are moved radially inward, whereby the friction materials 372 and the inner peripheral surface of the cylindrical portion 312 of the cover 31, engaged by friction, are disengaged from each other. As a result, the centrifugal clutch 37 is turned to an off state, and the power inputted to the cover 31 is not transmitted therefrom to the turbine 33 through the centrifugal clutch 37. In other words, the power inputted to the cover 31 is transmitted therefrom to the impeller 32 and is then transmitted to the turbine 33 through the hydraulic fluid.

### <Power Transmission Shaft 5>

As shown in FIGS. 1 and 2, the power transmission shaft 5 extends from the electric motor 2. When described in detail, the power transmission shaft 5 extends from the rotor 23 of the electric motor 2. The power transmission shaft 5 extends toward the torque converter 3. The rotational axis of the power transmission shaft 5 is substantially matched with that of the electric motor 2 and that of the torque converter 3.

The power transmission shaft 5 is configured to transmit the power, inputted thereto from the electric motor 2, to the torque converter 3. The power transmission shaft 5 is attached at the distal end thereof to the cover hub 313 of the torque converter 3. The power transmission shaft 5 is unitarily rotated with the rotor 23 of the electric motor 2. Because of this, the power transmission shaft 5 is rotated in the forward rotational direction.

The power transmission shaft 5 extends through the interior of the output shaft 11. The power transmission shaft 5 is solid. The power transmission shaft 5 includes a communicating pathway 51 in the distal end thereof. The communicating pathway 51 extends in the axial direction. The hydraulic fluid, discharged from the torque converter 3 through the cutout portions 333c and the through holes 313d, flows through the interior of the communicating pathway 51. Besides, the communicating pathway 51 is opened at the distal end surface of the power transmission shaft 5.

### <Human-powered Drive Unit>

As shown in FIG. 1, the human-powered drive unit 6 is configured to drive the drive wheels 101 through the torque converter 3. Besides, the human-powered drive unit 6 is configured to drive the drive wheels 101 by a human drive force.

The human-powered drive unit 6 includes a human-powered shaft 61, a pair of crank arms 62, a pair of pedals 63, and a human-powered transmission part 64. The human-powered shaft 61 is disposed to be rotatable. The human-powered shaft 61 is configured to be rotationally driven by the human drive force. The rotational axis of the human-powered shaft 61 extends substantially in parallel to the rotational axis O of the power transmission shaft 5.

The pair of crank arms 62 extends from the both ends of the human-powered shaft 61 in radial directions of the human-powered shaft 61. The pedals 63 are rotatably attached to the distal ends of the crank arms 62, respectively. The rotational axes of the pedals 63 are arranged approximately in parallel to the rotational axis of the human-powered shaft 61. The human drive force is inputted from the pedals 63 by pedaling the pedals 63. Accordingly, the human-powered shaft 61 is rotated in the forward rotational direction identical to the rotational direction of the power transmission shaft 5.

The human-powered transmission part 64 is configured to transmit the power, inputted to the human-powered shaft 61, to the power transmission shaft 5. When described in detail, the human-powered transmission part 64 includes a first sprocket 641, a second sprocket 642, and a chain 643.

The first sprocket 641 is attached to the human-powered shaft 61. The first sprocket 641 is unitarily rotated with the human-powered shaft 61.

The second sprocket 642 is attached to the power transmission shaft 5. The second sprocket 642 is disposed axially between the electric motor 2 and the power output part 4. Besides, the second sprocket 642 is disposed inside the power output part casing 40. The second sprocket 642 is attached to the power transmission shaft 5 through a second one-way clutch 13. Here, the second one-way clutch 13 corresponds to a one-way clutch in the present invention.

The second one-way clutch 13 is configured to allow transmitting the power from the human-powered transmission part 64 to the power transmission shaft 5 but block transmitting the power from the power transmission shaft 5 to the human-powered transmission part 64. Specifically, the second one-way clutch 13 transmits the rotation of the second sprocket 642 rotated in the forward rotational direction to the power transmission shaft 5. However, the second one-way clutch 13 does not transmit the rotation of the power transmission shaft 5 rotated in the forward rotational direction to the second sprocket 642. Because of this, even when the electric motor 2 is driven, the respective members of the human-powered drive unit 6 are not rotated.

The chain 643 is wrapped about the first and second sprockets 641 and 642. The chain 643 transmits the rotation of the first sprocket 641 to the second sprocket 642. In other words, the chain 643 transmits the rotation of the human-powered shaft 61 to the power transmission shaft 5. It should be noted that the human-powered transmission part 64 can include a belt instead of the chain 643.

### <Output Shaft 11>

The output shaft 11 outputs the power inputted thereto from the torque converter 3. The output shaft 11 outputs the power, inputted thereto from the torque converter 3, to the power output part 4. The output shaft 11 extends from the torque converter 3 toward the electric motor 2.

The output shaft 11 has a cylindrical shape. The power transmission shaft 5 extends through the interior of the output shaft 11. The output shaft 11 is attached at one end (the right end in FIG. 2) to the turbine 33 of the torque converter 3. On the other hand, the output shaft 11 is rotatably supported at the other end, for instance, by the power output part casing 40 through a bearing member and/or so forth.

### <Power Output Part 4>

The power output part 4 is disposed axially between the electric motor 2 and the torque converter 3. The power output part 4 is accommodated in the interior of the power output part casing 40. The power output part 4 outputs the power, inputted thereto from the torque converter 3, toward the drive wheels 101. When described in detail, the power output part 4 outputs the power, inputted thereto from the torque converter 3, to the drive wheels 101 through a differential gear 109. It should be noted that as described below, the power output part 4 does not output the power in a neutral mode.

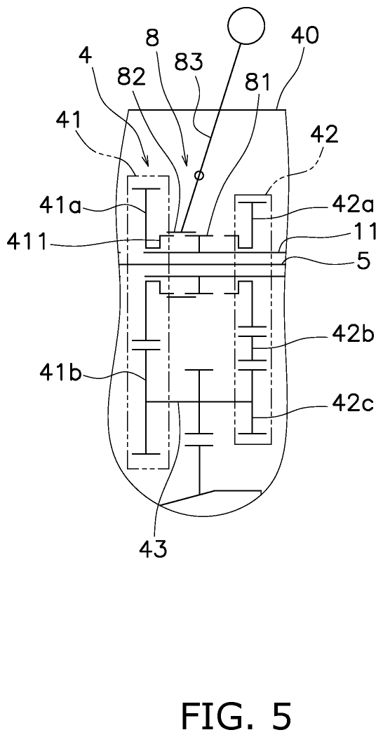

As shown in FIG. 5, the power output part 4 includes a first gear train 41 and a second gear train 42. The power output part 4 outputs the power therefrom through either the first gear train 41 or the second gear train 42. The first gear train 41 outputs the power, inputted to the power output part 4 from the torque converter 3, in a first rotational direction. The second gear train 42 outputs the power, inputted to the power output part 4 from the torque converter 3, in a second rotational direction. The second rotational direction is a rotational direction reverse to the first rotational direction.

The first rotational direction is a rotational direction corresponding to forward movement of the vehicle. The second rotational direction is a rotational direction corresponding to backward movement of the vehicle. Because of this, when the power is transmitted to the drive wheels 101 through the first gear train 41, the vehicle is moved forward. By contrast, when the power is transmitted to the drive wheels 101 through the second gear train 42, the vehicle is moved backward.

The first gear train 41 includes a first gear 41a and a second gear 41b that are meshed with each other. The first gear 41a is supported by the output shaft 11, while being rotatable relative thereto. When a ring gear 82 of the clutch mechanism 8 (to be described) is meshed with the first gear 41a, the first gear 41a is unitarily rotated with the output shaft 11.

The second gear 41b is supported by a drive shaft 43. The second gear 41b is unitarily rotated with the drive shaft 43. The second gear 41b outputs the power, inputted thereto from the first gear 41a, to the drive shaft 43.

The second gear train 42 includes a third gear 42a, a fourth gear 42b, and a fifth gear 42c. The number of gears in the second gear train 42 is greater by one than that in the first gear train 41. The third gear 42a is supported by the output shaft 11, while being rotatable relative thereto. When the ring gear 82 of the clutch mechanism 8 (to be described) is meshed with the third gear 42a, the third gear 42a is unitarily rotated with the output shaft 11.

The fourth gear 42b is meshed with the third gear 42a. The fourth gear 42b is supported by a countershaft (not shown in the drawings). The fourth gear 42b can be rotated unitarily with or relative to the countershaft.

The fifth gear 42c is meshed with the fourth gear 42b. The fifth gear 42c is supported by the drive shaft 43. The fifth gear 42c is unitarily rotated with the drive shaft 43. The fifth gear 42c outputs the power, inputted thereto from the third gear 42a, to the drive shaft 43.

The first gear train 41 has a different gear ratio from the second gear train 42. When described in detail, the second gear train 42 has a higher gear ratio than the first gear train 41.

The power output part 4 can be set to any of a first output mode, a second output mode, and the neutral mode. When in the first output mode, the power output part 4 outputs the power through the first gear train 41. By contrast, when in the second output mode, the power output part 4 outputs the power through the second gear train 42. On the other hand, when in the neutral mode, the power output part 4 does not output the power inputted thereto from the torque converter 3.

### <Clutch Mechanism>

The clutch mechanism 8 is configured to transmit the power from the torque converter 3 to the drive wheels 101 through the differential gear 109 and block transmission of the power.

When described in detail, the clutch mechanism 8 is configured to switch the power output part 4 from one to another among the first output mode, the second output mode, and the neutral mode. The clutch mechanism 8 includes a clutch hub 81, the ring gear 82, and a lever 83.

The clutch hub 81 is attached to the output shaft 11. The clutch hub 81 is unitarily rotated with the output shaft 11. The clutch hub 81 can be formed as a single member integrated with the output shaft 11, or alternatively, can be formed as a different member separated from the output shaft 11. The clutch hub 81 includes a plurality of teeth on the outer peripheral surface thereof

The ring gear 82 includes a plurality of teeth on the inner peripheral surface thereof. The ring gear 82 is constantly meshed with the clutch hub 81 and is unitarily rotated therewith. In other words, the ring gear 82 is unitarily rotated with the output shaft 11. The ring gear 82 is disposed to be movable in the axial direction.

As shown in FIG. 5, the ring gear 82 is meshed with the clutch hub 81 and is also capable of being turned to a state of engagement with the first gear 41a. When described in detail, the first gear 41a includes a first cylindrical portion 411 protruding in the axial direction. The first cylindrical portion 411 includes a plurality of teeth on the outer peripheral surface thereof. The ring gear 82 is herein meshed with the outer peripheral surface of the first cylindrical portion 411.

When the ring gear 82 is meshed with the clutch hub 81 and the first cylindrical portion 411 as described above, the power output part 4 is set to the first output mode. In other words, the power, inputted to the power output part 4 from the output shaft 11, is outputted through the first gear train 41.

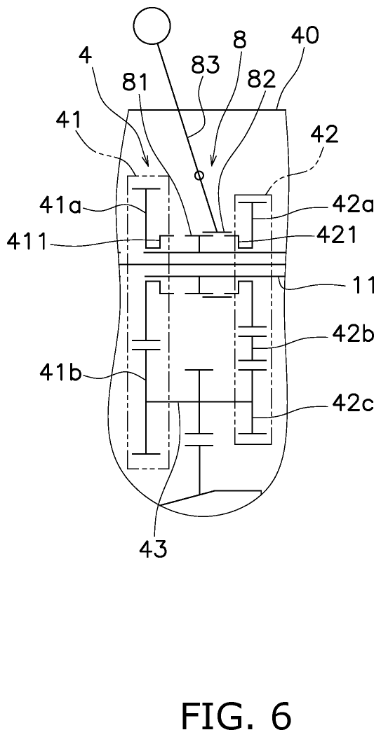

As shown in FIG. 6, the ring gear 82 is meshed with the clutch hub 81 and is also capable of being turned to a state of engagement with the third gear 42a. When described in detail, the third gear 42a includes a second cylindrical portion 421 protruding in the axial direction. The second cylindrical portion 421 includes a plurality of teeth on the outer peripheral surface thereof. The ring gear 82 is herein meshed with the outer peripheral surface of the second cylindrical portion 421.

When the ring gear 82 is meshed with the clutch hub 81 and the second cylindrical portion 421 as described above, the power output part 4 is set to the second output mode. In other words, the power, inputted to the power output part 4 from the output shaft 11, is outputted through the second gear train 42.

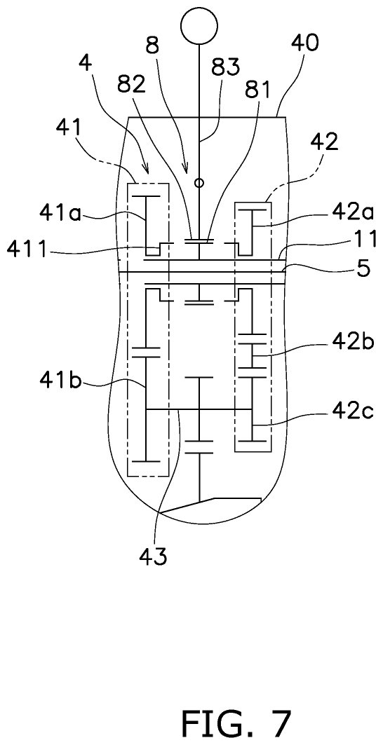

As shown in FIG. 7, the ring gear 82 is capable of being turned to a state of meshing with only the clutch hub 81. When the ring gear 82 is meshed with only the clutch hub 81 without being meshed with both the first and second cylindrical portions 411 and 421 as described above, the power output part 4 is set to the neutral mode. In other words, the power, inputted to the power output part 4 from the output shaft 11, is not outputted toward the drive wheels 101.

The lever 83 is coupled to the ring gear 82. The lever 83 extends from the ring gear 82 to the outside of the power output part casing 40. The lever 83 is operated by a driver. The ring gear 82 is axially movable in conjunction with operating the lever 83. The axial movement of the ring gear 82 results in meshing with the clutch hub 81 and the first cylindrical portion 411, meshing with the clutch hub 81 and the second cylindrical portion 421, or meshing with only the clutch hub 81. As a result, the clutch mechanism 8 enables the power output part 4 to be switched from one to another among the first output mode, the second output mode, and the neutral mode.

### <Actions>

In the drive device 100 configured as described above, the power output part 4 is set to the first output mode in forward movement of the vehicle. As a result, the power, inputted to the torque converter 3 from the electric motor 2, is outputted to the drive wheels 101 through the first gear train 41 of the power output part 4. By contrast, the power output part 4 is set to the second output mode in backward movement of the vehicle. As a result, the power, inputted to the torque converter 3 from the electric motor 2, is outputted to the drive wheels 101 through the second gear train 42 of the power output part 4. Thus, the rotational direction of the electric motor 2 and that of the torque converter 3 remain unchanged regardless of forward movement and backward movement of the vehicle. Because of this, the drive device 100 can amplify the torque not only in forward movement but also in backward movement.

On the other hand, in lack of electricity in the battery for driving the electric motor 2, traveling of the vehicle is enabled by the human-powered drive unit 6 instead of by the electric motor 2. In other words, when the driver pedals the pedals 63, the human-powered shaft 61 is rotated, whereby the power transmission shaft 5 is rotated through the human-powered transmission part 64. Then, the torque outputted from the power transmission shaft 5 is amplified in the torque converter 3 and the resultant torque is transmitted to the drive wheels 101. In other words, not only the torque outputted from the electric motor 2 but also that outputted from the human-powered drive unit 6 is amplified in the torque converter 3.

It should be noted that when the power transmission shaft 5 is rotated by the human-powered drive unit 6, the electric motor 2 is rotated as well. In other words, the electric motor 2 is made function as an electric generator, whereby the battery can be charged. Moreover, the power output part 4 can be set to the neutral mode by the clutch mechanism 8 in order to charge the battery as efficiently as possible.

### [Modifications]

One embodiment of the present invention has been explained above. However, the present invention is not limited to the above, and a variety of changes can be made without departing from the gist of the present invention.
(a) In the embodiment described above, the human-powered drive unit 6 is configured such that the human-powered shaft 61 is rotated by the pedals 63 and the rotation thereof is transmitted to the power transmission shaft 5 through the human-powered transmission part 64. However, the configuration of the human-powered drive unit 6 is not limited to this. For example, the pedals 63 can directly rotate and drive the power transmission shaft 5 through the crank arms 62. In other words, the human-powered drive unit 6 may not include the human-powered transmission part 64.
(b) In the embodiment described above, the clutch mechanism 8 is configured to switch the power output part 4 among the modes by manual operation of the lever 83. However, the configuration of the clutch mechanism 8 is not limited to this. For example, the clutch mechanism 8 is also enabled to switch the power output part 4 among the modes by electronic control or so forth.
(c) In the embodiment described above, the drive device 100 includes the clutch mechanism 8. However, the drive device 100 may not include the clutch mechanism 8.
(d) In the embodiment described above, the drive device 100 is installed in the electric car. Alternatively, the drive device 100 can be installed in any suitable vehicle other than the electric car.

### REFERENCE SIGNS LIST

2: Electric motor
3: Torque converter
5: Power transmission shaft
6: Human-powered drive unit
61: Human-powered shaft
64: Human-powered transmission part
643: Chain
8: Clutch mechanism
13: Second one-way clutch
100: Drive device
101: Drive wheel

What is claimed is:

1. A drive device configured to drive a drive part, the drive device comprising:
a fluid coupling;
an electric motor configured to drive the drive part through the fluid coupling; and
a human-powered drive unit configured to drive the drive part through the fluid coupling.

2. The drive device according to claim 1, further comprising:
a power transmission shaft configured to transmit a power inputted thereto from the electric motor to the fluid coupling, wherein
the human-powered drive unit includes
a human-powered shaft configured to be rotationally driven by a human drive force, and
a human-powered transmission part configured to transmit a power inputted thereto from the human-powered shaft to the power transmission shaft.

3. The drive device according to claim 2, wherein the human-powered transmission part includes either a chain or a belt.

4. The drive device according to claim 2, further comprising:
a one-way clutch configured to allow transmitting the power from the human-powered transmission part to the power transmission shaft and block transmitting the power from the power transmission shaft to the human-powered transmission part.

5. The drive device according to claim 1, further comprising:
a clutch mechanism configured to allow and block transmitting a power from the fluid coupling to the drive part.
